(19) United States
(12) Patent Application Publication
(10) Pub. No.: US 2004/0124001 A1
(43) Pub. Date: Jul. 1, 2004

(54) Overhead electrical cable with temperature sensing means

(76) Inventor: Eugene T. Sanders, Carrollton, GA (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/657,474

(22) Filed: Sep. 8, 2003

Related U.S. Application Data
(60) Provisional application No. 60/409,139, filed on Sep. 9, 2002.

(51) Int. Cl. H01B 5/08

(52) U.S. Cl. 174/128.1

(57) ABSTRACT

An electrical cable having a holding member arranged within the cable for an optic fiber, which can be used for temperature sensing and/or communications. The holding member can replace one or more strands of the cable, be placed inside an interstice of the cable, be placed in between various layers of the cable, or placed in the jacket of the cable. If desired a strength member may be adjacent to and/or attached to the holding member to provide additional protection for the optic fiber. The cable can be produced through the addition of a planetary strander device to a wire assembly apparatus.

### CROSS-REFERENCE TO RELATED APPLICATIONS

This application claims priority to provisional patent application Serial No. 60/409,139, which is relied on and incorporated herein by reference

### BACKGROUND OF THE INVENTION

The present invention relates to an electrical cable with a temperature sensing means, and more specifically, to an electric cable that utilizes an optic fiber temperature sensing means placed within the cable. It is desirable to accurately measure the temperature of a cable because the amount of electrical current that can be carried by a cable is limited by temperature. With accurate information regarding cable temperature, utility companies can make better use of their infrastructure.

It is relatively easy to estimate the temperature of a known conductor cable in a steady state ambient air temperature. In contrast, it is extremely difficult to determine the temperature of a cable under real world operating conditions due to the influence of wind, rain, solar radiation, and ever changing ambient air temperatures.

Conventional methods for measuring cable/conductor temperatures include Valley Group CAT-1 Tension Monitor, the EPRI Video Sagometer, and the USI donut. The CAT-1 method measures cable tension and weather conditions and the calculates the expected cable temperature using a thermal model. The EPRI Video Sagometer measures the cable sag and then calculates the expected cable temperature using a thermal elongation model. The USI donut uses two thermocouples placed on the outside surface of the transmission cable to measure its temperature at a single point. None of these methods measure the internal temperature of the cable/conductor or give real time temperature data for the length of the cable. Furthermore, they fail to satisfactorily measure cable temperature axially and radially throughout the entire length of the cable as can be obtained by the present invention.

The following U.S. patents describe temperature sensing with fiber optics and/or detail cables having optic fibers and electrical conductors.

U.S. Pat. No. 5,696,863 details fiber optic methods and devices for sensing physical parameters, like temperature or force.

U.S. Pat. No. 5,991,479 details distributed fiber optic sensors to measure temperature at different points along the fiber.

U.S. Pat. No. 4,852,965 details a composite optical fiber-copper conductor, which includes one or more reinforced optical fiber units and one or more metallic conductor pairs enclosed in a sheath system.

U.S. Pat. No. 4,952,020 details a ribbon cable having optical fibers and electrical conductors spaced side to side within a flexible jacket.,

U.S. Pat. No. 5,029,974 details a gel-filled plastic buffer tube for carrying optical fibers.

U.S. Pat. No. 5,651,081 details a composite fiber optic and electrical cable having a core which loosely contains at least one optical fiber, one or more electrical conductors having an outer polymer insulating layer, one or more strength members, and a surrounding protective jacket.

U.S. Pat. Nos. 5,917,977 and 6,049,647 detail a composite cable having a conductor and at least one fiber optic conductor in the core.

U.S. Pat. No. 6,072,928 relates to a tow cable for measuring temperature in a water column having a fiber optic core, an electrically conducting polymer jacket, and a temperature sensor embedded in the polymer jacket.

U.S. Pat. No. 6,236,789 details a composite cable for access networks having one or more buffer tubes, each buffer tube encircling at least two optical fibers for supplying optical signals to at least two of the units, each unit having electrical current and voltage requirements. The cable has a layer of S-Z stranded electrically insulated conductors around the buffer tube or tubes. The number of pairs of conductors is less than the number of active optical fibers which excludes conductor spares. Preferably, the buffer tubes are S-Z stranded. The cable also includes a strength member and an outer plastic jacket encircling the buffer tubes, the conductors and the strength member.

### SUMMARY OF THE INVENTION

The present invention comprises an electrical conductor/cable having a holding member or a protective tube for optic fibers. The holding member can contain one or more optic fibers. If desired a strength member may be adjacent to and/or attached to the holding member to provide additional protection for the optic fiber.

The holding member can be located in the interstices of the stranded cable or replace a strand of the cable. The holding member can be located in an interstice formed by the reinforcing strands and/or the conductive strands because the holding member has a diameter smaller than the size of an interstice. More than one holding member can be stranded into one or more interstices of the cable. The member can be placed in the cable in a longitudinal fashion or a helical wrap around the inner insulated cable. Alternatively, the holding member can replace a reinforcing strand and/or a conductive strand in the cable.

The holding member can be made so that it includes an optic fiber or it can be placed into the cable without an optic fiber. If an optic fiber is present, it can be used for temperature monitoring and/or communications. An optic fiber inside the a holding member could be used for similar or different functions when compared to another optical fiber that may be protected by the same or different holding member.

To determine temperature, an optic fiber can be used to accurately determine real-time thermal operating limits. For example, the optic fiber could be used to determine thermal properties of an overhead transmission line axially throughout the entire length of the line using distributed temperature sensing.

The holding member can be placed in a variety of electrical cables and should be resistant to crushing because the optic fiber within may be damaged and rendered useless if the member is crushed. Furthermore, it is also advantageous to distribute the pressure placed on the inner insulated conductor from such a member. Distribution of pressure results in less indentation of the outer layer of the insulation of the core conductor by the member, which would be to the advantage of maintaining the integrity of the insulation.

To achieve resistance to crushing and distribute pressure, the fiber holding member may have an oval outer periphery. The member can be made completely of stainless steel or a combination of stainless steel and dielectric type plastic. The member can be made in several configurations to have void areas in which to locate optic fibers, gel, and the like.

To avoid twisting an optical fiber contained in a holding member, the holding member may be placed longitudinally in the jacket material. The holding member is placed in this position during the process of placing the jacket onto a cable with either a core/neutral wire assembly or core/welded armor assembly. The holding member is longitudinally placed on the core assembly then the plastic jacket is extruded on this assembly effectively embedding the member into the jacket.

The holding member may alternatively be added to the neutral layer or substituted for a neutral strand. The holding member would have the same spiraling position along the cable as the neutrals. The application of the holding member in the same position as the neutrals requires a planetary strander to keep from introducing a twist to the holding member and the fiber contained within. By placing the holding member onto the cable longitudinally the holding member containing the fiber is not twisted.

Other ways to avoid twisting include placing the holding member longitudinally between the core and the bed tape of the cable, or placing the holding member longitudinally between the neutral strand layer and the water swellable tape.

The holding member can be stranded into electrical cables by a device placed on the up-stream side of the flyer placing the layer that the tube(s) need to go under, into or on top of. The device would be a planetary type strander designed to hold the number of the holding members that need to be placed in the cable.

For placing the members under the layer of the strands, the device would have a signal generator that rotates the device's planetary flyer in unison with the spiral configuration of the pre-stranded core passing through the device. This can be done by sensing the passage of the core and counting the passage of strands, human input to the device would tell it how many strands were in the outer layer of the core thus generating a signal to rotate the planetary flyer in unison with the lay of the outer layer of the core. If the core passing through was not pre-stranded and is being stranded by a up-stream flyer of the rigid frame strander from the device, then the device could sense the rotation of the up-stream flyer and rotate the planetary flyer in unison with the up-stream flyer placing members on top of the core making them end up under the strands of the down-stream flyer.

For placing the holding member into or on top of the layer of down-stream, flyer the device would have a signal generator that rotates the device's planetary flyer in unison with the rotation of the down-stream flyer placing the tube(s) on the same spiral lay as the layer being placed by the down-stream flyer.

Alternatively, the fiber optic member can be stranded into an electrical cable by a device placed between the flyer and the closing block holder of the strander so that the holding member goes into or into the interstices of that layer. The device would be a planetary type strander designed to hold the number of fiber containing protective tubes that need to be placed in the particular layer of the cable.

For placing the fiber optic member into a layer or into the interstices of the strands of a layer the device would have a signal sensing drive or direct mechanical drive that rotates the device's planetary flyer in unison with the flyer of the layer that device is applying the tube(s) in or on to. The fiber optic member would share a common closing block with the strands coming from the rigid frame flyer that the device is placed in.

If desired a strength member may be adjacent to and/or attached to the holding member to provide additional protection for the optic fiber.

### BRIEF DESCRIPTION OF THE DRAWINGS

FIG. 1a is a schematic cross section of a core of an electrical cable having a holding member in an interstice.

FIG. 1b is a schematic cross section showing several holding members located in various interstices.

FIG. 1c is a schematic cross section showing a holding member replacing a reinforcing strand.

FIG. 1d is a cross section wherein the holding member replaces a conducting strand.

FIG. 1e is a cross section wherein the holding member replaces a conducting strand.

FIG. 1f depicts another cross section of a core where the holding member replaces one of the reinforcing strands.

FIG. 2a is a schematic of a wire assembly apparatus to make the present invention with prestranded core

FIG. 2b is a schematic of a wire assembly apparatus to make the present invention.

FIG. 2c is a schematic of an alternative wire assembly apparatus to make the present invention.

FIG. 2d is a schematic of another embodiment of a wire assembly to make the present invention.

### DETAILED DESCRIPTION

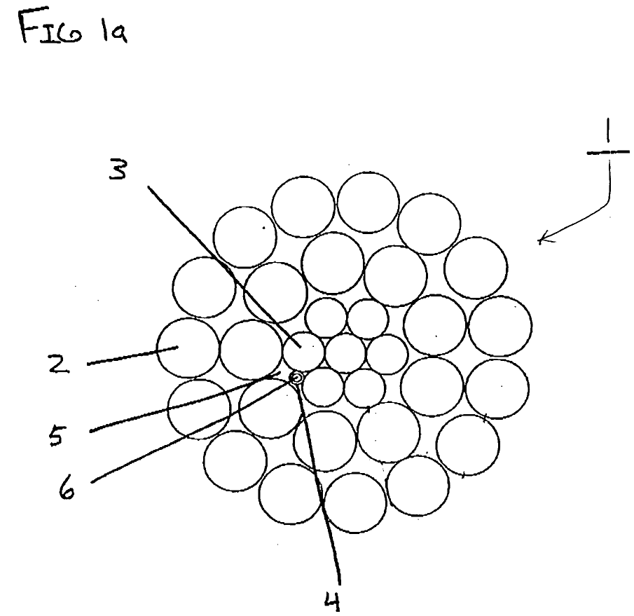

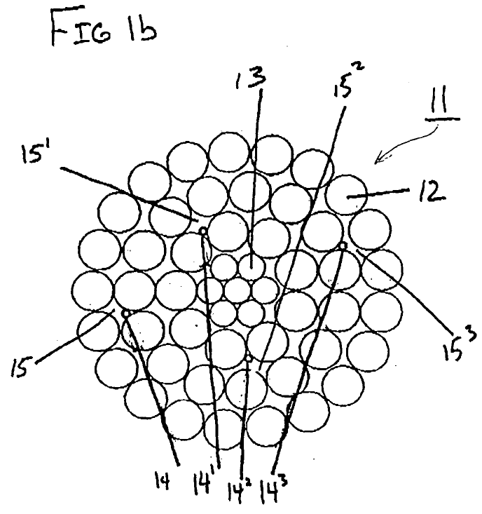

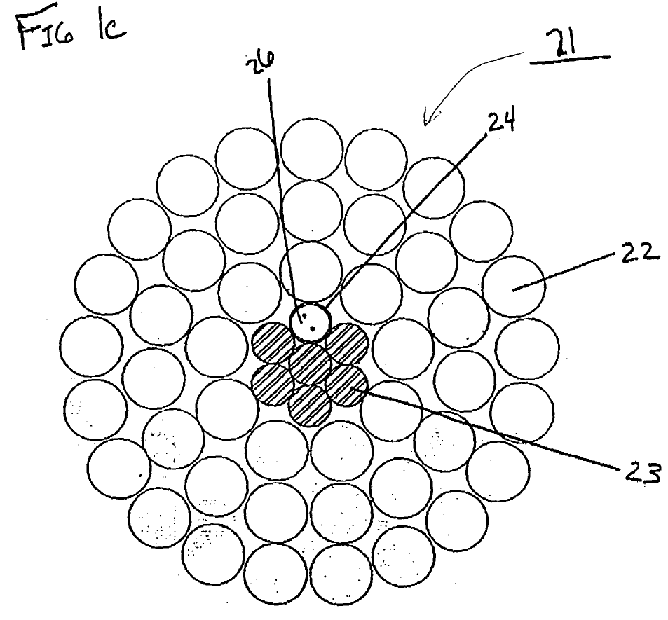

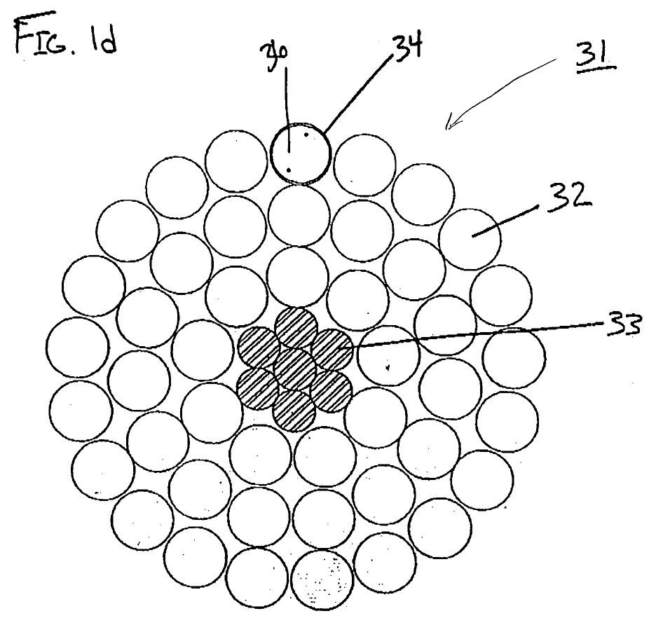

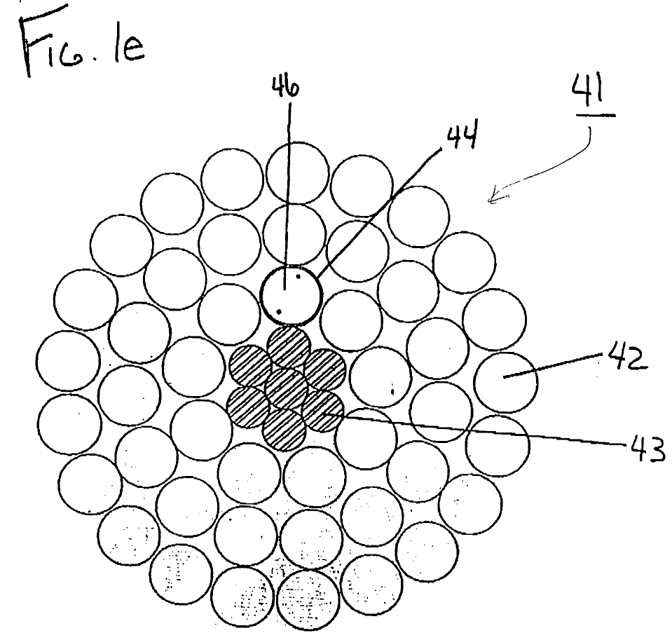

FIG. 1a depicts a schematic cross section of a core (1) of an electrical conductor or cable, which is formed from a plurality of reinforcing strands (3) and a plurality of conductive strands (2). The conducting strands (2) are located near the outer periphery of the core (1) and surround the reinforcing strands (3), which are located near the center of the core (1). A holding member (4) is located in the interstices (5) of the core (1) formed by the shape of the conducting strands (2) and/or the reinforcing strands (3), both of which may have a larger diameter than the holding member (4). The holding member (4) can be a protective device such as a tube having a circular cross section. Although the illustrated embodiment depicts one holding member (4) in an interstice (5), it is possible to have more than one holding member (4) in an interstice (5). The holding member (4) can potentially be located anywhere within the core (1) and can contain an optic fiber for temperature monitoring, communications, or a combination of both.

The holding member (4) surrounds at least one optical fiber (6). Because of the operating temperatures of the cable, it is preferable to use an optical fiber (6) that is heat resistant and can withstand high temperatures. For example, an optical fiber (6) with a polyimid coating could be used which allows operating temperatures up to 300° C. Alternatively, the optical fiber (6) can be made from heat resistant materials, such as quartz. Furthermore, the holding member (4) could also be gel-filled for to block water.

FIG. 1b depicts a schematic cross section of a core (11) of an electrical cable, which is formed from reinforcing strands (13) and conductive strands (12). Several holding members (14, 14¹, 14², and 14³) are located in the interstices (15, 15¹, 15², and 15³) of the core (11).

FIG. 1c depicts a cross section of a core (21) of a “bluejay” style of a cable having conducting strands (22) forming an outer periphery of the core (21) and reinforcing strands (23) located near the center of the core (21). For example, the center of the core (21) can be formed from six reinforcing strands (23) and one holding member (24) containing an optic fiber (26). The holding member (24) may have approximately the same diameter as the individual reinforcing strands (23), which enables the holding member (24) to replace at least one of the reinforcing strands (23) in the core (21) of the cable without causing any structural deformities. The illustrated embodiment does not suffer from ampacity loss, while only having approximately 5% strength loss. The location for temperature monitoring is good, but the location of the holding member (24) causes termination to be difficult.

FIG. 1d depicts a cross section of a core (31) of a “bluejay” style of a cable having conducting strands (32) forming an outer periphery of the core (31) and reinforcing strands (33) located near the center of the core (31). The holding member (34) may have approximately the same diameter as one of the individual conducting strands (32), which enable the holding member (34) to replace a conducting strand (32). In the illustrated embodiment, the holding member (34) is located on the outer periphery of core (31) without causing any structural deformities and contains an optic fiber (36). The illustrated embodiment has an ampacity loss of around 1% at 75° C., which may be expected in standard operating temperatures under the influence of sun and wind. This embodiment has a strength loss of approximately 1.5-2%. The location for temperature monitoring is good because it is near the conducting strands (32). The location of the fiber optic conducting member (34) near the outer periphery of the core (31) causes termination to be easy.

FIG. 1e depicts a cross section of a core (41) of a “bluejay” style of a cable having conducting strands (42) forming an outer periphery of the core (41) and reinforcing strands (43) located near the center of the core (41). The holding member (44) can be approximately the same diameter as one of the conducting strands (42), which enables the holding member (44) to replace a conducting strand (42) near the reinforcing strands (43). The holding member (44) contains an optic fiber (46). The illustrated embodiment has an ampacity loss of around 1% at 75° C., which may be expected in standard operating temperatures under the influence of sun and wind. This embodiment has a strength loss of approximately 1.5-2% when compared to an unaltered core. The location for temperature monitoring is good because it is near the conducting strands (42), but the location of the fiber optic conducting member (44) near the reinforcing strands (43) causes termination to be difficult.

FIG. 1f depicts a cross section of a core (51) of a “45/19” ACSR style of a cable having conducting strands (52) forming an outer periphery of the core (51) and reinforcing strands (53) located near the center of the core (51). The holding member (54) may have approximately the same diameter as the reinforcing strands (53), which enables the holding member (54) to replace a reinforcing strand (53) in the core (51) of the cable without causing any structural deformities. This embodiment does not suffer from any ampacity loss, has around a 2% decrease in strength when compared to a normal cable. Termination of the embodiment is difficult, but the holding member (54) has a good location for measuring temperature.

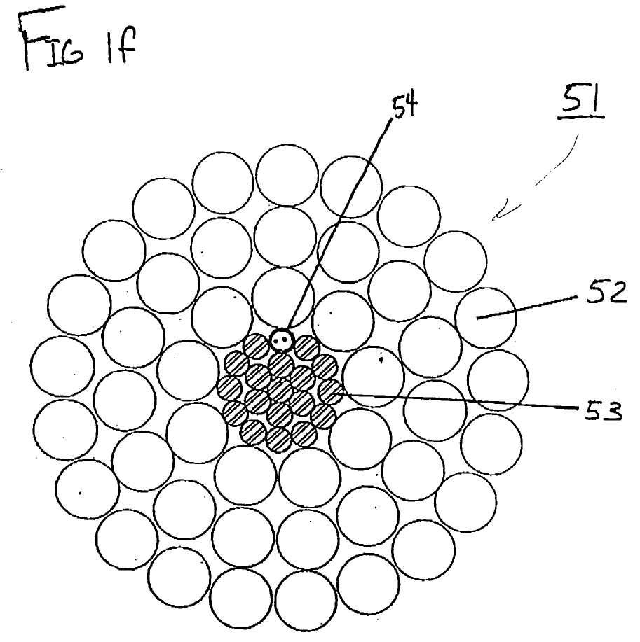

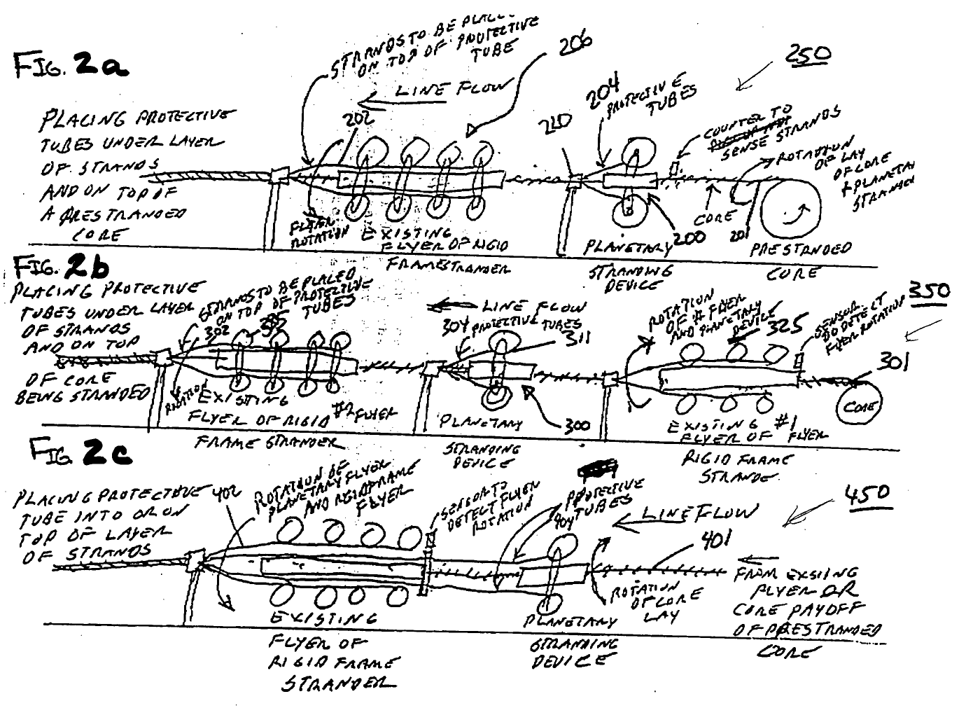

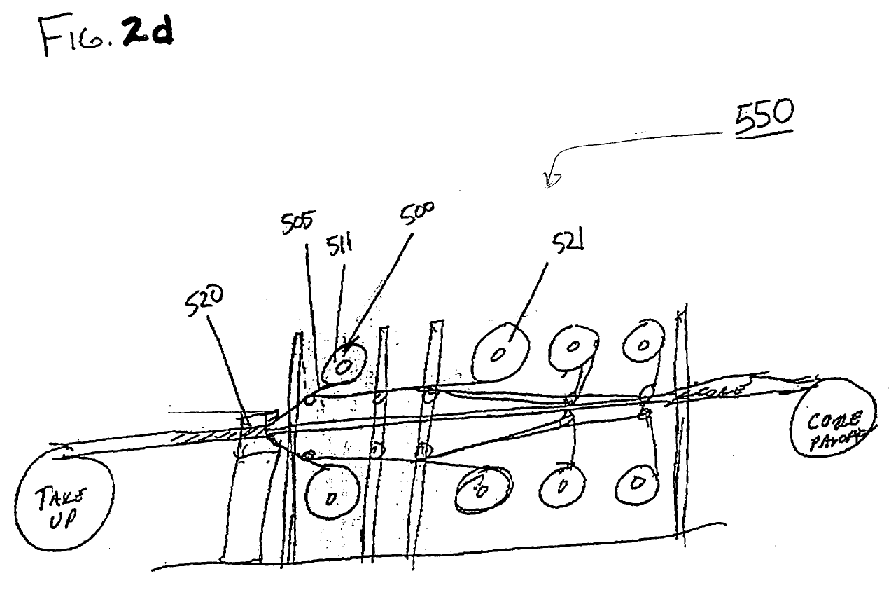

FIG. 2a relates to a method of manufacturing the present invention with a planetary strander device (200), which forms a part of a wire assembly apparatus (250). A prestranded core strand (201) is fed into the strander device (200) in the direction of the arrow. A holding member (204) is then placed onto the core strand (201) and passes through a compression die (220). The holding member (204) and core strand (201) are subsequently covered by additional strands (202). This allows the holding member to be located near the center of the cable.

For placing the holding member (204) under the layer of the additional strands (202), the device (200) has a sensor (210) that directs a planetary flyer (211) to rotate in unison with the spiral configuration of the core strand (201) passing through the strander device (200). This can be done by sensing the passage of the core (201) and counting the passage of strands, human or computer input to the device (200) would tell it how many strands were in the outer layer of the core (201) thus generating a signal to rotate the planetary flyer (211) in unison with the lay of the outer layer of the core (201).

After the core strand (201) is stranded with the holding member (204), it passes through a downstream conventional rigid frame strander (206) that places additional strands (202) onto the core (201) and holding member (204).

FIG. 2b depicts a second wire assembly apparatus (350), which is similar to the wire assembly apparatus (250) shown in FIG. 8a. A core strand (301) is formed and then fed into the planetary strander device (300). A holding member (304) is then placed onto the core strand (301). The holding member (304) and core strand (301) are subsequently covered by additional strands (302). The second wire assembly apparatus (350) creates a core strand (301) that is then stranded with a holding member (304). The planetary stranding device (300) has a sensor that senses the rotation of the up-stream flyer (325) and rotates the planetary flyer (311) in unison with the up-stream flyer (325) placing at least one holding member (304) on top of the core strand (301). The core strand (301) and the holding member (304) are then passed through a compression die (320) and eventually covered by additional strands (302) of the down-stream flyer (335).

FIG. 2c depicts a third wire assembly apparatus (450). A core strand (401) can be fed into the apparatus (450). The holding member is placed (404) into the layer of additional strands (402) that are placed on the core strand (401). This allows the holding member (404) to be near the outer periphery of the cable. A holding member (404) is placed on a core strand (401) without passing through a compression die (420) and subsequently additional strands (402) are placed on the holding member (404) and the core strand (401). The third wire assembly apparatus (450) has a planetary stranding device (400) which is controlled by a sensor (410) that initiates rotation of the planetary flyer (411) in unison with the rotation of the down-stream flyer (406) to placing the holding member (404) on the same spiral lay of additional strands (402) being placed by the down-stream flyer (421).

FIG. 2d depicts another wire assembly apparatus (550) which places the holding member (505) into an interstice (not shown). The planetary strander device (500) is designed to hold one or more holding members (505) that are to be placed in the particular layer of the cable. For placing the holding member (505) into a layer or into the interstices of the strands of a layer, the device (500) would have a signal sensing drive or direct mechanical drive that matches the rotation of the device's planetary flyer (511) with the rotation of the flyer (521) applying the additional strands (502). Applying the holding member (505) and the additional strands (502) to the core strand (501). The holding member (505) and additional strands (502) pass through a common closing block (520).

Advantageously the present invention is an electrical cable comprising reinforcing strands; conducting strands surrounding the reinforcing strands and located near the outer periphery thereof; a holding member containing an optic fiber located in an interstice of the electrical cable; and advantageously at least one strength member adjacent the holding member providing additional protection to the optic fiber. More advantageously the present cable has two strength members adjacent the holding member. Preferably the strength member is attached to the holding member. Advantageously the strength member is an electrically conductive material. Preferably the electrically conductive material is copper.

One embodiment of the present invention is an electrical cable comprising strands forming a core of the cable; a holding member containing an optic fiber, wherein the holding member replaces at least one of the strands; and at least one strength member adjacent the holding member. Advantageously the strands are comprised of conducting strands located near the outer periphery of the core and reinforcing strands that are surrounded by the conducting strands; and wherein the holding member and strength member replace at least one of the reinforcing strands. The holding member and strength member may replace at least one of the reinforcing strands near the conducting strands. Alternatively the holding member and strength member may replace at least one of the conducting strands. The present cable may further comprise a second holding member that replaces at least one of the conducting strands.

The present invention further embodies a method of manufacturing an electrical cable having strands forming a core of the cable; a holding member containing an optic fiber, wherein the holding member replaces at least one of the strands; and at least one strength member adjacent the holding member comprising feeding a core strand into a strander device; and placing a holding member on the core strand.

The present invention also embodies a method of manufacturing an electrical cable having strands forming a core of the cable; a holding member containing an optic fiber, the holding member may replace at least one of the strands; and at least one strength member is adjacent the holding member, and wherein the holding member and strength member may alternatively or additionally replace at least one of the reinforcing strands near the conducting strands; comprising feeding a core strand into a strander device, placing a holding member on the core strand, and covering the core strand and the holding member with additional strands.

The present invention also encompasses a method of manufacturing an electrical cable having a conducting core; a layer of insulating/bedding tape surrounding the core; a corrugated welded armor surrounding the layer of insulation/bedding tape; a first holding member arranged longitudinally along the cable between the layer of insulation/bedding tape and the corrugated welded armor; and at least one strength member adjacent the first holding member comprising feeding a core strand into a strander device having a flyer for applying additional strands and a planetary flyer for a holding member, matching the rotation of the flyer with the rotation of the planetary flyer, and applying the additional strands and the holding member to the core strand.

Further variations and modifications of the foregoing will be apparent to those skilled in the art and are intended to be encompassed by the claims appended hereto.

What is claimed is:

1. An electrical cable comprising:
reinforcing strands;
conducting strands surrounding the reinforcing strands and located near the outer periphery thereof; and
a holding member containing an optic fiber located in an interstice of the electrical cable.

2. The cable of claim 1 having a strength member adjacent the holding member.

3. The cable of claim 2 wherein the strength member is attached to the holding member.

4. The cable of claim 2 wherein the strength member is an electrically conductive material.

5. The cable of claim 4 wherein the electrically conductive material is copper.

6. The cable of claim 2 wherein the diameter of the strength member is greater than the diameter of the holding member.

7. The cable of 1 wherein the holding member is a steel tube.

8. An electrical cable comprising:
strands forming a core of the cable; and
a holding member containing an optic fiber, wherein the holding member replaces at least one of the strands.

9. The electrical cable of claim 8, wherein the strands are comprised of conducting strands located near the outer periphery of the core and reinforcing strands that are surrounded by the conducting strands.

10. The cable of claim 9, wherein the holding member replaces at least one of the reinforcing strands.

11. The cable of claim 9, wherein the holding member replaces at least one of the conducting strands.

12. The cable of claim 9, further comprising a second holding member that replaces at least one of the conducting strands.

13. The cable of claim 9, further comprising a second holding member that replaces at least one of the reinforcing strands.

14. An electrical cable, comprising:
a conductive core;
a means for holding an optic fiber; and
a means for strengthening the holding means.

15. A method of manufacturing the cable of claim 8, comprising:
feeding a core strand into a strander device; and
placing a holding member on the core strand.

16. A method of manufacturing the cable of claim 10, comprising:
feeding a core strand into a strander device, placing a holding member on the core strand; and
covering the core strand and the holding member with additional strands.

17. A method of manufacturing the cable of claim 8, comprising:
feeding a core strand into a strander device having a flyer for applying additional strands and a planetary flyer for a holding member,
matching the rotation of the flyer with the rotation of the planetary flyer; and
applying the additional strands and the holding member to the core strand.
